(19) United States
(12) Patent Application Publication
(10) Pub. No.: US 2026/0134884 A1
(43) Pub. Date: May 14, 2026

(54) OPTICAL RECORDING MEDIUM MANUFACTURING METHOD, AND TRANSFER APPARATUS FOR OPTICAL RECORDING MEDIUM

(71) Applicant: SONY GROUP CORPORATION, TOKYO (JP)

(72) Inventors: TAKAHIKO FUKUSHIMA, TOKYO (JP); RYOTARO TAKAHASHI, SHIZUOKA (JP)

(21) Appl. No.: 18/704,111

(22) PCT Filed: Oct. 26, 2022
(86) PCT No.: PCT/JP2022/039939

§ 371 Date: Apr. 24, 2024

(30) Foreign Application Priority Data
Nov. 2, 2021 (JP) 2021-179773

(51) Int. Cl. G11B 7/26

(52) U.S. Cl. CPC G11B 7/263

(57) ABSTRACT

An optical recording medium manufacturing method is provided that suppresses generation of a swelling along the outer periphery of the surface of an optical recording medium.

The optical recording medium manufacturing method includes coating an ultraviolet-curing resin on a recording layer of a substrate, placing the substrate coated with the ultraviolet-curing resin onto an elastic sheet of a vacuum press apparatus, and pressing a stamper onto the ultraviolet-curing resin to transfer unevenness thereto. A press pressure at the time of the transfer is 11,875 N or less, and a press time at the time of the transfer is 0.8 s or less.

### TECHNICAL FIELD

The present disclosure relates to an optical recording medium manufacturing method and a transfer apparatus for an optical recording medium.

### BACKGROUND ART

In recent years, techniques for creating multiple recording layers have been widely adopted to increase a storage capacity of optical recording media. A multilayered optical recording medium has intermediate layers with uneven surfaces interposed between recording layers. Unevenness over the intermediate layers is formed by coating an ultraviolet-curing resin on the recording layers and by pressing a stamper onto the resin to transfer the unevenness thereto.

PTL 1 describes a vacuum transfer apparatus that transfers the unevenness of a stamper onto an ultraviolet-curing resin.

### CITATION LIST

### Patent Literature

### [PTL 1]

Japanese Patent Application Laid-open No. 2009-32312

### SUMMARY

### Technical Problem

However, manufacturing a multilayer optical recording medium by use of a vacuum transfer apparatus entails generating a swelling along an outer periphery of a surface (signal plane) of the optical recording medium. The swelling on the surface of the optical recording medium can affect a laser beam of an optical pickup system, which can lead to defects during writing or reading.

An object of the present disclosure is to provide an optical recording medium manufacturing method and a transfer apparatus for an optical recording medium, the method and the apparatus being capable of suppressing generation of a swelling along the outer periphery of the surface of the optical recording medium.

### Solution to Problem

In solving the above problem and according to a first aspect of the disclosure, there is provided an optical recording medium manufacturing method including:

coating an ultraviolet-curing resin on a recording layer of a substrate, placing the substrate coated with the ultraviolet-curing resin onto an elastic sheet of a vacuum press apparatus, and pressing a stamper onto the ultraviolet-curing resin to transfer unevenness thereto, in which a press pressure at a time of the transfer is 11, 875 N or less and a press time at the time of the transfer is 0.8 s or less.

According to a second aspect of the disclosure, there is provided an optical recording medium manufacturing method including coating a first ultraviolet-curing resin on a recording layer of a substrate and curing the resin, coating a second ultraviolet-curing resin on the first ultraviolet-curing resin, placing the substrate coated with the second ultraviolet-curing resin onto an elastic sheet of a vacuum press apparatus, and pressing a stamper onto the second ultraviolet-curing resin to transfer unevenness thereto, in which a press pressure at a time of the transfer is 11, 875 N or less and a press time at the time of the transfer is 0.8 s or less.

According to a third aspect of the disclosure, there is provided a transfer apparatus for an optical recording medium including a vacuum press apparatus configured to press a stamper onto an ultraviolet-curing resin to transfer unevenness thereto, and a control apparatus configured to control the vacuum press apparatus, in which the vacuum press apparatus includes: a ram capable of holding the stamper, a table capable of placing an elastic sheet, and a drive apparatus capable of moving the ram in a direction approaching the table as well as in a direction separating therefrom; and in which the control apparatus controls the drive apparatus in such a manner that a press pressure becomes 11,875 N or less and that a press time becomes 0.8 s or less.

### BRIEF DESCRIPTION OF DRAWINGS

FIG. 1 is a sectional view depicting an exemplary structure of an optical recording medium.

FIG. 2 is a sectional view depicting an exemplary structure of multiple information signal layers.

FIG. 3 is a schematic view depicting an exemplary configuration of a transfer apparatus for an optical recording medium as an embodiment of the present disclosure.

FIG. 4 is a flowchart describing an exemplary optical recording medium manufacturing method as an embodiment of the present disclosure.

FIGS. 5A, 5B, and 5C are each a process chart describing the optical recording medium manufacturing method as an embodiment of the present disclosure.

FIGS. 6A and 6B are each a process chart describing the optical recording medium manufacturing method as an embodiment of the present disclosure.

FIG. 7 is a sectional view depicting a modification example of an elastic sheet.

FIG. 8 is a graph indicating measurement results of a thickness T ranging from the surface of a layer L0 to the surface of a light-transmitting layer.

FIG. 9A is a graph indicating measurement results of a thickness Tu ranging from the surface of the layer L0 to the surface of a first ultraviolet-curing resin layer. FIG. 9B is a graph indicating measurement results of a thickness T₁₂ ranging from the surface of the layer L0 to the surface of a second ultraviolet-curing resin layer before transfer. FIG. 9C is a graph indicating measurement results of a thickness T₁₃ ranging from the surface of the layer L0 to the surface of the second ultraviolet-curing resin layer after transfer.

FIG. 10 is a graph indicating measurement results of the thickness Tu ranging from the surface of the layer L0 to the surface of the first ultraviolet-curing resin layer, measurement results of the thickness T₁₂ ranging from the surface of the layer L0 to the surface of the second ultraviolet-curing resin layer before transfer, and measurement results of the thickness T₁₃ ranging from the surface of the layer L0 to the surface of the second ultraviolet-curing resin layer after transfer.

FIG. 11 is a graph indicating measurement results of the thickness T₁₂ ranging from the surface of the layer L0 to the surface of the second ultraviolet-curing resin layer before transfer, and measurement results of the thickness T₁₃ ranging from the surface of the layer L0 to the surface of the second ultraviolet-curing resin layer after transfer.

FIG. 12A is a graph indicating measurement results of the thickness T after 5 times of transfer. FIG. 12B is a graph indicating measurement results of the thickness T after 1, 300 times of transfer.

FIG. 13A is a graph indicating measurement results of the surface of an unused silicone sheet. FIG. 13B is a graph indicating measurement results of the surface of the silicone sheet after 200 times of transfer. FIG. 13C is a graph indicating measurement results of the surface of the silicone sheet after 500 times of transfer.

FIG. 14A is a graph indicating measurement results of the amount of swelling along the outer periphery of the surface of a layer S1. FIG. 14B is a graph indicating measurement results of the amount of swelling along the outer periphery of the surface of a layer S2. FIG. 14C is a graph indicating measurement results of the amount of swelling along the outer periphery of the surface of an optical recording medium.

### DESCRIPTION OF EMBODIMENTS

Some embodiments of the present disclosure will be described below with reference to the accompanying drawings, the description being made in the following order:
1. Structure of optical recording medium
2. Configuration of transfer apparatus for optical recording medium
3. Optical recording medium manufacturing method
4. Processes of forming intermediate layers
5. Advantageous effects
6. Modification examples

### 1. STRUCTURE OF OPTICAL RECORDING MEDIUM

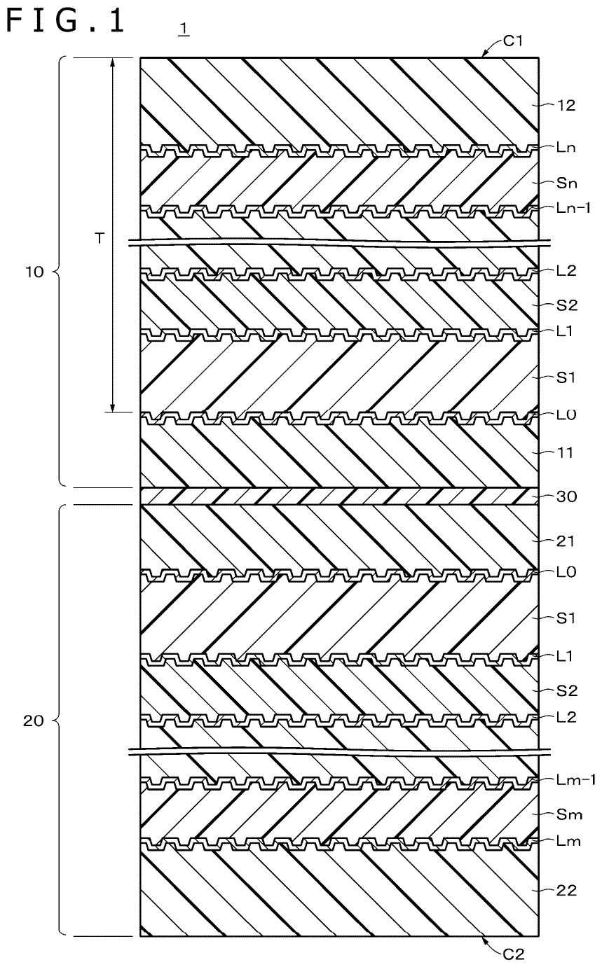

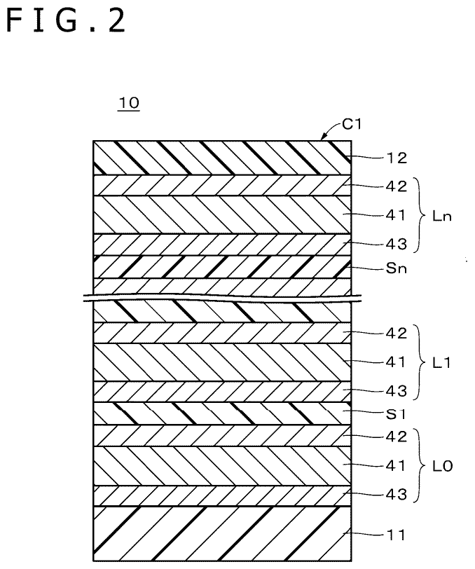

Explained below with reference to FIGS. 1 and 2 is an exemplary structure of an optical recording medium 1 fabricated by an optical recording medium manufacturing method as an embodiment of the present disclosure.

The optical recording medium 1 is a generally-called multilayer write-once optical recording medium (e.g., AD (Archival Disc)) that includes a first disc 10, a second disc 20, and a bonding layer 30 interposed between the first disc 10 and the second disc 20. The optical recording medium 1 may operate on a principle of having data written to both groove tracks and land tracks thereof. The optical recording medium 1 is shaped like a disc having an opening at a center (referred to as “center hole” hereunder). Incidentally, a shape of the optical recording medium 1 is not limited to a disc; other suitable shapes may also be adopted.

The first disc 10 is structured to have an information signal layer L0, an intermediate layer S1, an information signal layer L1, . . . , an intermediate layer Sn, an information signal layer Ln, and a light-transmitting layer 12 as a cover layer, stacked in that order on a principal surface of a substrate 11. The second disc 20 is structured to have an information signal layer L0, an intermediate layer S1, an information signal layer L1, . . . , an intermediate layer Sm, an information signal layer Lm, and a light-transmitting layer 22 as a cover layer, stacked in that order on a principal surface of a substrate 21. It is to be noted that the numbers “n” and “m” are each an independent integer of at least one and preferably two or larger in view of increasing the recording capacity. In the description that follows, the information signal layers L0 through Ln and the information signal layers L0 through Lm will be generically referred to as the information signal layer L where they are not individually distinguished. The intermediate layers S1 through Sn and the intermediate layers S1 through Sm will be generically referred to as the intermediate layer S where they are not individually distinguished.

The optical recording medium 1 has light irradiation surfaces on both sides that are irradiated by a laser beam for writing or reading information signals. More specifically, the optical recording medium 1 has a first light irradiation surface C1 irradiated by the laser beam for writing or reading information signals to or from the first disc 10, and a second light irradiation surface C2 irradiated by the laser beam for writing or reading information signals to or from the second disc 20.

On the first disc 10, the information signal layer L0 is positioned the deepest in reference to the first light irradiation surface C1. The information signal layers L1 through Ln are positioned above the information signal layer L0. This allows the laser beam for writing or reading to be transmitted through the information signal layers L1 through Ln. On the second disc 20, on the other hand, the information signal layer L0 is positioned the deepest in reference to the second light irradiation surface C2. The information signal layers L1 through Lm are positioned above the information signal layer L0. This allows the laser beam for writing or reading to be transmitted through the information signal layers L1 through Lm. Although not depicted, the optical recording medium 1 may have a hard coat layer provided on the surface of the light-transmitting layer 12 (i.e., on the first light irradiation surface C1) or on the surface of the light-transmitting layer 22 (i.e., on the second light irradiation surface C2).

On the optical recording medium 1, information signals are written to or read from the first disc 10 in the following manner. That is a laser beam is applied from the first light irradiation surface C1 on the side of the light-transmitting layer 12 to each of the information signal layers L included in the first disc 10. This allows the information signals to be written to or read from the first disc 10. For example, a laser beam having a wavelength ranging from 350 to 410 nm inclusive is focused by an objective lens having a numerical aperture ranging from 0.84 to 0.86 inclusive. The laser beam thus focused is applied from the side of the light-transmitting layer 12 to each of the information signal layers L included in the first disc 10, thereby writing or reading the information signals to or from the information signal layers.

On the other hand, information signals are written to or read from the second disc 20 in the following manner. That is a laser beam is applied from the second light irradiation surface C2 on the side of the light-transmitting layer 22 to each of the information signal layers L included in the second disc 20. This allows the information signals to be written to or read from the second disc 20. For example, a laser beam having a wavelength ranging from 350 to 410 nm inclusive is focused by an objective lens having a numerical aperture ranging from 0.84 to 0.86 inclusive. The laser beam thus focused is applied from the side of the light-transmitting layer 22 to each of the information signal layers L included in the second disc 20, thereby writing or reading the information signals to or from the information signal layers.

The substrates 11 and 21, bonding layer 30, information signal layer L, intermediate layer S, and light-transmitting layers 12 and 22 constituting the optical recording medium 1 are explained below in that order.

### (Substrates)

The substrates 11 and 21 are each shaped like a disc having a center hole at the center, for example. One principal surface of the substrates 11 and 21 is an uneven surface, for example, on which the information signal layer L0 is deposited. In the ensuing paragraphs, the bumps of the unevenness on the surface will be referred to as the lands Ld and the recesses thereof as the grooves Gv.

The lands Ld and grooves Gv may each be in any of various shapes such as a spiral or a concentric shape. The lands Ld and/or the grooves Gv may be wobbled (meandered) in order to stabilize linear velocity and to add address information.

Note that, the spiral directions of the first disc 10 and second disc 20 may be opposed to each other. In this case, the first disc 10 and the second disc 20 bonded together to form the optical recording medium (double-sided disc) 1 can be written and read at the same time, approximately doubling the data transfer rate for writing and reading.

The outer diameter of the substrates 11 and 21 (diameter) is selected to be 120 mm, for example. The inner diameter of the substrates 11 and 21 (diameter) is selected to be 15 mm, for example. A thickness of the substrate 11 is selected preferably to be from 0.3 to 0.545 mm inclusive and more preferably to be from 0.445 to 0.545 mm inclusive in consideration of stiffness.

The material for the substrates 11 and 21 may be a plastic material or glass, for example. In view of moldability, it is preferred to use the plastic material. The plastic material may be a polycarbonate resin, a polyolefin resin, or an acrylic resin, for example. In view of cost, it is preferred to use the polycarbonate resin.

### (Bonding Layer)

The bonding layer 30 bonds the first disc 10 and the second disc 20 together. More specifically, the bonding layer 30 bonds together the substrate 11 of the first disc 10 and the substrate 21 of the second disc 20 in such a manner that the light-transmitting layers 12 and 22 each appear on the surface side. The bonding layer 30 is constituted by a hardened ultraviolet-curing resin, for example.

A thickness of the bonding layer 30 is between 0.01 mm and 0.22 mm inclusive, for example. The ultraviolet-curing resin may be a radical polymerization ultraviolet-curing resin, for example.

### (Information Signal Layer)

As depicted in FIG. 2, the information signal layer L is structured to include a recording layer 41 having a first surface and a second surface, a dielectric layer (first dielectric layer) 42 adjacent to the recording layer 41 on the side of the first surface thereof, and a dielectric layer (second dielectric layer) 43 adjacent to the recording layer 41 on a side of the second surface thereof. This structure improves a durability of the recording layer 41. Here, the first surface refers to one of the two principal surfaces of the recording layer 41 which is opposite to the first light irradiation surface C1 (i.e., surface irradiated by a laser beam for writing or reading information signals). The second surface refers to the surface opposite to the first surface (i.e., surface opposite to the substrate 11).

### (Recording Layer)

The recording layer 41 is structured to let information signals be written thereto under irradiation by the laser beam. Specifically, the recording layer 41 is structured to be able to form recording marks under irradiation by the laser beam. The recording layer 41 may be an inorganic recording layer, for example, which includes as the principal ingredient a metallic oxide constituting an inorganic recording material. The metallic oxide may be an inorganic recording material including a manganese oxide (MnO-based material), an inorganic recording material including a palladium oxide (PdO-based material), an inorganic recording material including a copper oxide (CuO-based material), or an inorganic recording material including a silver oxide (AgO-based material), for example.

A thickness of the recording layer 41 is preferably between 25 nm and 60 nm inclusive and more preferably between 30 nm and 50 nm inclusive.

### (Dielectric Layers)

The dielectric layers 42 and 43 each function as an oxygen barrier layer. This improves the durability of the recording layer 41. The dielectric layers 42 and 43 may also have a function of suppressing the escape of oxygen from the recording layer 41. This suppresses changes in the film properties of the recording layer 41, allowing the recording layer 41 to retain its favorable film properties. The dielectric layers 42 and 43 may further have a function of improving recoding properties.

The dielectric layers 42 and 43 each include a dielectric material. The dielectric material includes, for example, at least one material selected from the group including oxide, nitride, sulfide, carbide, and fluoride. The materials for the dielectric layers 42 and 43 may be of the same type or may be different from each other. The oxide may be an oxide of at least one element selected from the group including In, Zn, Sn, Al, Si, Ge, Ti, Ga, Ta, Nb, Hf, Zr, Cr, Bi, and Mg, for example. The nitride may be a nitride of at least one element selected from the group including In, Sn, Ge, Cr, Si, Al, Nb, Mo, Ti, Nb, Mo, Ti, W, Ta, and Zn; and preferably from the group including Si, Ge, and Ti, for example. The sulfide may be a Zn sulfide, for example. The carbide may be a carbide of at least one element selected from the group including In, Sn, Ge, Cr, Si, Al, Ti, Zr, Ta, and W; and preferably from the group including Si, Ti, and W, for example. The fluoride may be a fluoride of at least one element selected from the group including Si, Al, Mg, Ca, and La, for example. Specific examples of these mixtures are: ZnS—SiO₂, SiO₂—In₂O₃—ZrO₂ (SIZ), SiO₂—Cr₂O₃—ZrO₂ (SCZ), In₂O₃—SnO₂ (ITO), In₂O₃—CeO₂ (ICO), In₂O₃-Ga203 (IGO), In₂O₃—Ga₂O₃—ZnO (IGZO), Sn₂O₃—Ta₂O₅ (TTO), TiO₂—SiO₂, Al₂O₃-Zno, and Al₂O₃—BaO.

A thickness of the dielectric layer 43 may preferably range from 2 to 30 nm inclusive. A thickness of the dielectric layer 42 may preferably range from 2 to 50 nm inclusive.

### (Intermediate Layer)

The intermediate layer S has a role of separating the information signal layers L at a physically and optically sufficient distance. The intermediate layer S, serving as a light path for the laser beam for writing and reading data to and from deeper layers, may preferably have a sufficiently high optical transparency. The intermediate layer S has an uneven surface on the side irradiated by the laser beam for writing or reading information signals. The uneven surface forms lands Ld and grooves Gv in a concentric or spiral pattern, for example. The thickness of the intermediate layer S may preferably be between 9 μm and 50 μm inclusive. The intermediate layer S is constituted by a hardened ultraviolet-curing resin, for example.

### (Light-Transmitting Layers)

The light-transmitting layer 12 covers the information signal layer Ln. The light-transmitting layer 22 covers the information signal layer Lm. The light-transmitting layers 12 and 22 are each constituted by a hardened ultraviolet-curing resin, for example. An example of the ultraviolet-curing resin is an ultraviolet-curing acrylic resin. The light-transmitting layers 12 and 22 each may alternatively be constituted by a light-transmitting sheet having a circular shape and by a bonding layer bonding the light-transmitting layer to the information signal layer Ln or Lm. The light-transmitting sheet may preferably include a material having a low absorptive capacity with respect to the laser beam used for writing and reading. Specifically, the light-transmitting sheet may include a material with a transmittance of at least 90%. As the material for the light-transmitting sheet, polycarbonate resin or polyolefin resin (e.g., ZEONEX (registered trademark)) may be used, for example. As the material for the bonding layer, ultraviolet-curing resin or pressure-sensitive adhesive (PSA) may be used, for example.

The thickness of the light-transmitting layers 12 and 22 may preferably be selected from between 10 μm and 177 μm inclusive, and typically selected to be 57 μm. These thin light-transmitting layers 12 and 22, in combination with an object lens having a high NA of approximately 0.85, for example, permit high-density recording.

### (Hard Coat Layer)

The hard coat layer provides abrasion resistance to the first and second light irradiation surfaces C1 and C2. The material for the hard coat layer may be an acrylic resin, a silicone resin, a fluorine resin, or an organic or inorganic hybrid resin, for example. The hard coat layer may also include inorganic particles such as silica particles so as to ensure higher mechanical strength.

### 2. CONFIGURATION OF TRANSFER APPARATUS FOR OPTICAL RECORDING Medium

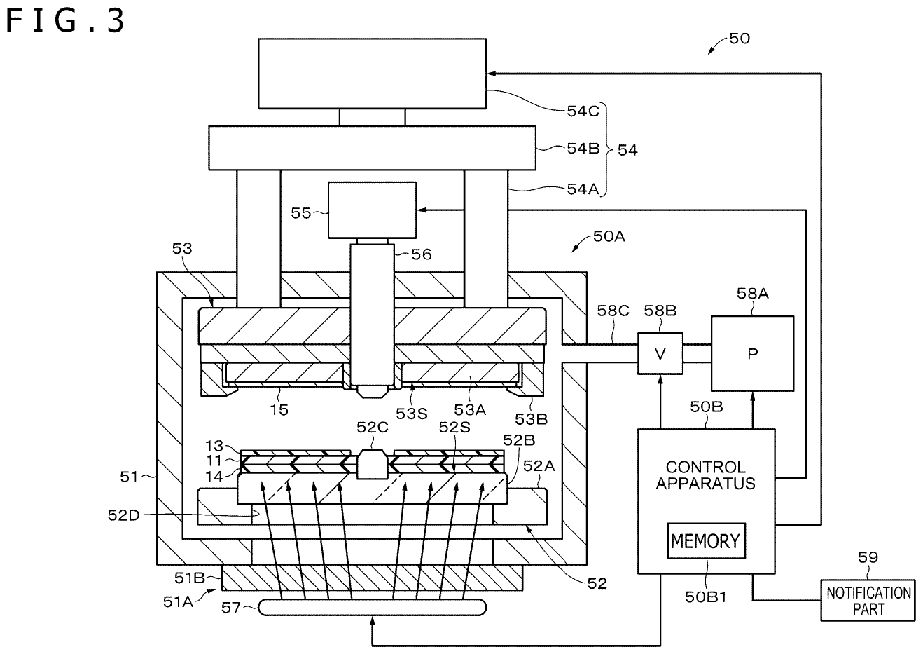

Explained below with reference to FIG. 3 is an exemplary configuration of a transfer apparatus 50 for an optical recording medium as an embodiment of the present disclosure. The transfer apparatus 50 may preferably be used to manufacture an optical recording medium 1 having a recording capacity of at least 500 GB. This is because when the optical recording medium 1 has the recording capacity of at least 500 GB, recording/reproducing characteristics are affected significantly by the swelling along the outer periphery (e.g., a region ranging from 50 to 57 mm in radius) of the optical recording medium 1.

The transfer apparatus 50 for the optical recording medium is used to fabricate the intermediate layer S and includes a vacuum press apparatus 50A and a control apparatus 50B.

### (Vacuum Press Apparatus)

The vacuum press apparatus 50A is used to form the intermediate layer S by pressing a stamper 15 onto an ultraviolet-curing resin layer 13 on the information signal layer L in a vacuum environment so as to transfer unevenness to the layer 13. The vacuum press apparatus 50A includes a vacuum chamber 51, a table 52, a ram 53, a drive apparatus 54, a drive apparatus 55, an eject pin 56, an ultraviolet irradiation apparatus 57, a vacuum pump 58A, a vacuum valve 58B, a notification part 59, a load lock chamber (not depicted), and a table drive apparatus (not depicted). The vacuum press apparatus 50A may have two tables 52.

The vacuum chamber 51 is used to provide a vacuum environment for transfer. The vacuum chamber 51 houses the table 52 and the ram 53. The vacuum chamber 51 is connected to the vacuum pump 58A via the vacuum valve 58B. The vacuum pump 58A depressurizes the vacuum chamber 51 by discharging gas therefrom. At the bottom of the vacuum chamber 51 is a window 51A that transmits the ultraviolet light emitted from the ultraviolet irradiation apparatus 57. The window 51A of the vacuum chamber 51 is constituted by a high-strength glass plate 51B against destruction at the time of depressurizing.

The table 52 has a placement surface 52S on which an elastic sheet 14 can be placed. The substrate 11 is placed on the elastic sheet 14. The table 52 permits transmission of the incident light from the back side opposite to the placement surface 52S. The table 52 is positioned in the vacuum chamber 51 in a manner opposed to the ram 53. The table 52 can be moved between the load lock chamber and the vacuum chamber 51 by the table drive apparatus, not depicted. The table 52 has a holder 52A, a glass tray 52B, and a center pin 52C.

The holder 52A supports the glass tray 52B in a manner opposed to the ram 53. The holder 52A has an opening 52D through which the ultraviolet light emitted from the ultraviolet irradiation apparatus 57 is transmitted. The glass tray 52B has the placement surface 52S opposed to the ram 53. For example, the placement surface 52S is circular in shape when viewed from a direction perpendicular to the placement surface 52S.

The center pin 52C is inserted to the center hole of the elastic sheet 14 and to the center hole of the substrate 11. The center pin 52C is positioned at the center of the placement surface 52S.

The elastic sheet 14 is used to evenly distribute over the ultraviolet-curing resin layer 13 the pressurizing force applied by the stamper 15 thereto. The elastic sheet 14 is circular in shape when viewed from a direction perpendicular to the principal surface of the elastic sheet 14. At the center of the elastic sheet 14 is a center hole (opening). A silicone sheet may preferably be used as the elastic sheet 14.

The ram 53 is used to press the stamper 15 onto the substrate 11 placed on the table 52. The ram 53 is capable of holding the stamper 15. The ram 53 is circular in shape. The ram 53 includes a mold 53A and an outer peripheral ring 53B.

The mold 53A is used to transfer unevenness onto the ultraviolet-curing resin layer 13. The mold 53A has a press surface 53S corresponding to the table 52. The press surface 53S has a specular appearance. The stamper 15 is placed on the press surface 53S. The outer peripheral ring 53B is capable of holding the outer periphery of a molding surface of the stamper 15 placed on the press surface 53S. The mold 53A has, at its center, a through-hole in which the eject pin 56 is inserted.

The stamper 15 has an uneven molding surface on the side opposed to the table 52. The unevenness is intended to form an uneven surface of the intermediate layer S. In view of durability, a metal stamper may preferably be used as the stamper 15. The metal stamper is constituted by a metallic material such as nickel.

The eject pin 56 is used to peel off, from the stamper 15, the ultraviolet-curing resin layer 13 onto which the unevenness has been transferred. The tip of the eject pin 56 is projected from the center of the press surface 53S toward the table 52.

The eject pin 56 is capable of ejecting compressed gas such as compressed air from its tip part in an in-plane direction of the press surface 53S. Specifically, the tip part of the eject pin 56 has multiple holes (not depicted). The multiple holes are connected to a compressor (not depicted). The compressor is capable of compressing gas such as air and ejecting the compressed gas through the multiple holes.

The drive apparatus 55 is capable of moving the eject pine 56 up and down. Specifically, the drive apparatus 55 is capable of moving the eject pin 56 in a direction approaching the placement surface 52S of the table 52 as well as in a direction separating therefrom. The drive apparatus 55 supports the upper end of the eject pin 56. For example, an actuator such as a motor may be used as the drive apparatus 55.

The drive apparatus 54 is a generally-called lifting apparatus that lifts and lowers the ram 53. Specifically, the drive apparatus 54 is capable of moving the ram 53 in a direction approaching the placement surface 52S of the table 52 as well as in a direction separating therefrom. The placement surface 52S of the table 52 and the press surface 53S of the ram 53 are held in parallel with each other.

The drive apparatus 54 includes multiple shafts 54A, a holder 54B, and a motor 54C as an actuator. The multiple shafts 54A hold the ram 53. One end of the multiple shafts 54A is introduced into the vacuum chamber 51 via multiple through-holes at the top thereof and connected to the upper surface of the ram 53. The gap between the shafts 54A and the through-holes is sealed by a leakage-preventing member such as a packing in such a manner that the shafts 54A can move up and down while leakage is prevented. The other end of the multiple shafts 54A is connected to the holder 54B. The holder 54B holds the multiple shafts 54A. The holder 54B is connected to the motor 54C. The motor 54C is capable of lifting and lowering the holder 54B.

The ultraviolet irradiation apparatus 57 irradiates the back side of the substrate 11 by ultraviolet light via the window 51A of the vacuum chamber 51 and through the opening 52D of the holder 52A. The ultraviolet irradiation apparatus 57 is located outside the vacuum chamber 51. The ultraviolet irradiation apparatus 57 is arranged opposite to the base of the vacuum chamber 51, i.e., opposite to the window 51A. In this embodiment, it is explained that the ultraviolet irradiation apparatus 57 is located outside the vacuum chamber 51 as an example. Alternatively, the ultraviolet irradiation apparatus 57 may be located inside the vacuum chamber 51. As the ultraviolet irradiation apparatus 57, at least one apparatus may be selected from the group including a UV lamp, a metal halide lamp, a xenon flash lamp, and a UV-LED (Light Emitting Diode).

The vacuum pump 58A depressurizes the vacuum chamber 51 by discharging gas therefrom. The vacuum pump 58A is connected to the vacuum chamber 51 via an air release pipe 58C. The vacuum valve 58B is capable of adjusting the amount of gas flowing through the air release pipe 58C. The vacuum valve 58B is arranged in the air release pipe 58C connecting the vacuum chamber 51 with the vacuum pump 58A.

Under control of the control apparatus 50B, the notification part 59 notifies that the elastic sheet 14 placed on the table 52 be replaced. For example, an indicating lamp or an alarm may be used as the notification part 59. Each of these devices may be used alone, or they may be used in combination.

The load lock chamber is used to convey the substrate 11 into the vacuum chamber 51 and to carry the substrate 11 out thereof. The load lock chamber is connected to a vacuum pump (not depicted) and a vacuum valve (not depicted). Under control of the control apparatus 50B, the vacuum pump evacuates the load lock chamber to depressurize its interior down to a prescribed degree of vacuum. The vacuum valve opens the load lock chamber to the atmosphere. In the case where the vacuum press apparatus 50A has two tables 52, the load lock chamber and the vacuum chamber 51 may be assigned one table 52 each, the two tables 52 being made interchangeable between the load lock chamber and the vacuum chamber 51.

### (Control Apparatus)

The control apparatus 50B is capable of controlling the vacuum press apparatus 50A. Specifically, the control apparatus 50B is capable of controlling the drive apparatus 54, drive apparatus 55, vacuum pump 58A, vacuum valve 58B, and ultraviolet irradiation apparatus 57, for example. The control apparatus 50B is connected to an administrative apparatus (host computer) that manages the entire manufacturing process of the optical recording medium 1. The control apparatus 50B may transmit information such as operation status of the vacuum press apparatus 50A to the administrative apparatus.

A computer customized to control the vacuum press apparatus 50A or a general-purpose computer (e.g., personal computer), for example, may be used as the control apparatus 50B. The control apparatus 50B includes an input apparatus (not depicted), a monitor (not depicted), and a memory 50B1 serving as a storage part.

The input apparatus can be used to input control information for controlling the vacuum press apparatus 50A, as well as to start and stop the vacuum press apparatus 50A. Buttons, keys, a touch panel, or a keyboard, for example, may be used as the input apparatus. These devices may each be used alone, or they may be utilized in combination.

The monitor can display diverse information such as the control information regarding the vacuum press apparatus 50A and the operation status thereof. An organic EL display (Organic Light Emitting Diodes: OLED), an LED (Light Emitting Diode) display, or a liquid crystal display, for example, may be used as the monitor. These devices may each be used alone, or they may be utilized in combination.

The memory 50B1 stores the press pressure (load) of the vacuum press apparatus 50A upon transfer, the press time of the vacuum press apparatus 50A upon transfer, the number of transfers following replacement of the elastic sheet 14 (press count), and the number of transfers for replacement of the elastic sheet 14. When a worker performs prescribed input operations on the input apparatus following replacement of the elastic sheet 14, the control apparatus 50B resets the number of transfers stored in the memory 50B1. For example, a semiconductor memory such as a nonvolatile memory may be used as the memory 50B1. The number of transfers for replacement of the elastic sheet 14 is the information indicating the time to replace the elastic sheet 14. The number of transfers for replacement of the elastic sheet 14 is between 10,000 and 20,000 inclusive, and more specifically 15,000, for example.

The control apparatus 50B controls the drive apparatus 54 to lift and lower the ram 53. On the basis of the press pressure (load) and the press time stored in the memory 50B1, the control apparatus 50B controls the operation of the drive apparatus 54 at the time of transfer, i.e., the operation of pressing the stamper 15 onto the ultraviolet-curing resin layer 13. The upper limit of the press pressure (load) upon transfer is 11, 875 N or less, and preferably 2,375 N or less. The upper limit of the press time upon transfer is 0.8 s or less, and preferably 0.4 s or less. In a case where the upper limit of the press pressure upon transfer is 11, 875 N or less and where the press time upon transfer is 0.8 s or less, it is possible to suppress generation of the swelling along the outer periphery of the intermediate layer S. This in turn makes it possible to suppress generation of the swelling along the outer periphery of the optical recording medium 1. Note that the press pressure above is applicable in the case where the diameter of the optical recording medium 1 is 120 mm.

The lower limit of the press pressure at the time of transfer is preferably 2, 375 N or higher, and more preferably 8,313 N or higher. When the lower limit of the press pressure (load) upon transfer is 2,375 N or higher, it is possible to suppress generation of bubble defects in the ultraviolet-curing resin layer 13. The lower limit of the press time upon transfer is preferably 0.4 s or longer, and more preferably 0.8 s or longer. When the lower limit of the press time upon transfer is 0.4 s or longer, it is possible to suppress generation of bubble defects in the ultraviolet-curing resin layer 13. Here, the bubble defects refer to bubbles that can occur in the gap between the ultraviolet-curing resin layer 13 and the stamper 15 when the stamper 15 is pressed onto the ultraviolet-curing resin layer 13 in a vacuum environment. For example, the bubble defects are formed by a group of very small bubbles of between 10 μm and 30 μm inclusive in diameter each.

The press pressure at the time of transfer is set to a prescribed value in reference to the press pressure stored in the memory 50B1. The upper limit of the press pressure upon transfer is 1.05 N/mm² or less, and preferably 0.21 N/mm² or less. When the upper limit of the press pressure upon transfer is 1.05 N/mm² or less and the upper limit of the press time upon transfer is 0.8 s or less, it is possible to suppress generation of the swelling along the outer periphery of the intermediate layer S. This in turn makes it possible to suppress generation of the swelling along the outer periphery of the optical recording medium 1. The lower limit of the press pressure at the time of pressing with the stamper 15 is preferably 0.21 N/m² or higher. When the lower limit of the press pressure is 0.74 N/m² or higher, it is possible to suppress generation of bubble defects in the ultraviolet-curing resin layer 13.

On the basis of the press pressure stored in the memory 50B1, the control apparatus 50B controls the drive apparatus 54 to put a prescribed press pressure to the ram 53. The control apparatus 50B counts the number of transfers following replacement of the elastic sheet 14. Specifically, the control apparatus 50B stores the number of transfers after replacement of the elastic sheet 14 into the memory 50B1. Every time the substrate 11 (specifically, ultraviolet-curing resin layer 13) is pressed by the vacuum press apparatus 50A, the control apparatus 50B increments the number of transfers stored in the memory 50B1.

Every time the vacuum press apparatus 50A performs its press operation, the control apparatus 50B determines whether or not the number of transfers (press count) stored in the memory 50B1 has reached a prescribed transfer count (i.e., transfer count prompting replacement of the elastic sheet 14). When the number of transfers is determined to have reached the prescribed transfer count, the control apparatus 50B requests the administrative apparatus (host computer) managing the whole manufacturing process of the optical recording medium 1 to stop the production lines of the optical recording medium 1, and stops the press operation of the vacuum press apparatus 50A at the same time. Also, the control apparatus 50B controls the notification part 59 to notify workers of the need to replace the elastic sheet 14. On the other hand, when the number of transfers is determined not to have reached the prescribed transfer count, the control apparatus 50B increments the transfer count stored in the memory 50B1 while allowing the press operation of the vacuum press apparatus 50A to continue.

### 3. OPTICAL RECORDING MEDIUM MANUFACTURING METHOD

Explained below is an example of the optical recording medium manufacturing method as an embodiment of the present disclosure. The method embodying the present disclosure may preferably be used to manufacture an optical recording medium 1 having a recording capacity of at least 500 GB. This is because when the optical recording medium 1 has the recording capacity of at least 500 GB, the recording/reproducing characteristics of the medium 1 are affected significantly by the swelling along its outer periphery (e.g., a region ranging from 52 to 57 mm inclusive in radius).

### (Process of Forming Substrate 11)

First, the substrate 11 with unevenness formed on a principal surface thereof is fabricated. An injection molding method (injection), for example, may be used for fabricating the substrate 11.

### (Process of Depositing Information Signal Layer L0)

Next, the information signal layer L0 is deposited on the substrate 11 by stacking the dielectric layer 43, recording layer 41, and dielectric layer 42 successively on the substrate 11 by sputtering, for example.

### (Process of Forming Intermediate Layer S1)

Next, a spin coating method, for example, is used to coat an ultraviolet-curing resin on the information signal layer L0 to form the ultraviolet-curing resin layer 13 thereon. Thereafter, the transfer apparatus 50 is used to transfer unevenness to the ultraviolet-curing resin layer 13, thereby forming the intermediate layer S1 on the information signal layer L0.

(Process of Forming Information Signal Layers L1 Through Ln and process of forming intermediate layers S2 through Sn)

Next, in a manner similar to the above process of depositing the information signal layer L0 and the above process of forming the intermediate layer S1, the information signal layer L1, intermediately layer S2, information signal layer L2, . . . , intermediate layer Sn, and information signal layer Ln are stacked in that order on the intermediate layer S1.

### (Process of Forming Light-Transmitting Layer)

Next, the spin coating method, for example, is used to coat an ultraviolet-curing resin on the information signal layer Ln to form an ultraviolet-curing resin layer thereon. Thereafter, the ultraviolet-curing resin layer is irradiated with ultraviolet light to be cured. This is how the light-transmitting layer 12 is formed on the information signal layer Ln. The above processes combine to produce the desired optical recording medium 1.

### 4. PROCESSES OF FORMING INTERMEDIATE LAYERS

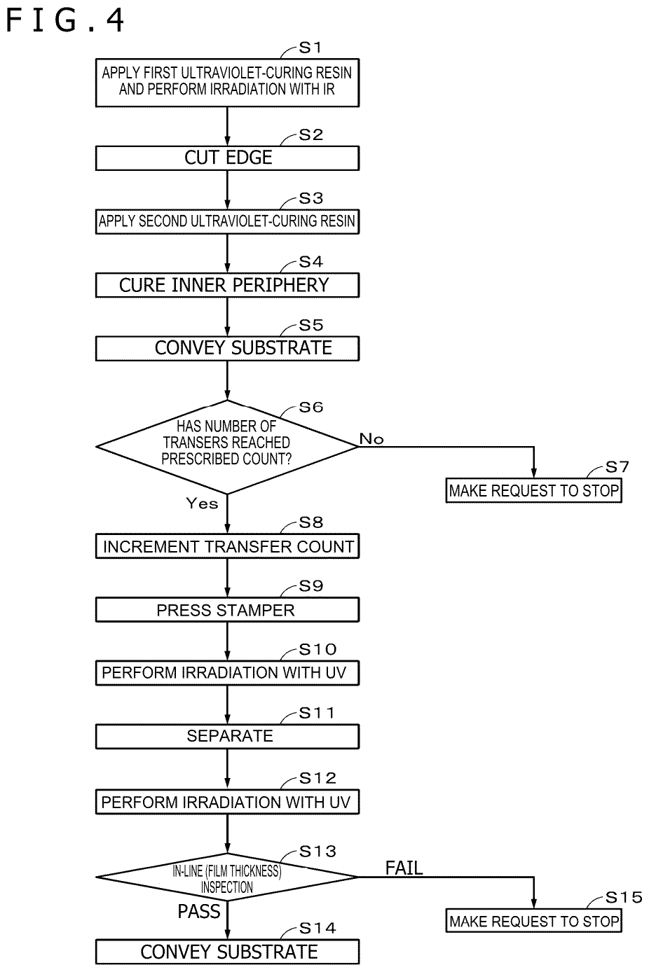

A detailed example of the process of forming the above-mentioned intermediate layer S1 is explained below with reference to FIGS. 3, 4, 5A, 5B, 5C, 6A, and 6B.

### (Process of Conveying Substrate)

First, a conveying apparatus conveys the substrate 11 with the information signal layer L0 formed thereon from a sputtering apparatus to a spin coating apparatus. The substrate 11 is placed on a spin tray of the spin coating apparatus.

### (Process of Coating First Ultraviolet-Curing Resin)

Next, in step S1, the spin coating apparatus drips a first ultraviolet-curing resin serving as a base layer to either the inner periphery of the uneven surface of the substrate 11 or the center of the substrate 11, to let the first ultraviolet-curing resin spread from the inner periphery toward the outer periphery of the substrate 11. This forms a first ultraviolet-curing resin layer on the information signal layer L of the substrate 11. While being spread out, the first ultraviolet-curing resin is irradiated along the outer periphery of the uneven surface of the substrate 11 by infrared light from an infrared irradiation apparatus in the spin coating apparatus. This lowers the viscosity of the first ultraviolet-curing resin spread along the outer periphery of the uneven surface of the substrate 11. The lowered viscosity prevents the thickness of the first ultraviolet-curing resin layer from increasing from the inner periphery toward the outer periphery of the substrate 11. Next, with an outer periphery mask covering the outer periphery of the uneven surface of the substrate 11, an ultraviolet irradiation apparatus in the spin coating apparatus irradiates the uneven surface of the substrate 11 with ultraviolet light. This hardens the first ultraviolet-curing resin layer formed on the uneven surface of the substrate 11. At this time, the first ultraviolet-curing resin layer may not be completely hardened and may be elastic, as in a half-cured state. When the first ultraviolet-curing resin layer remains elastic, the press pressure applied to a second ultraviolet-curing resin layer in a subsequent stamper transfer process, to be discussed later, can be mitigated. This further suppresses generation of the swelling along the outer periphery of the intermediate layer S1. In step S2, the swelling of the first ultraviolet-curing resin layer formed along the outer periphery of a film-forming surface of the substrate 11 is removed by rotation of the spin tray of the spin costing apparatus (i.e., by centrifugal force).

### (Process of Coating Second Ultraviolet-Curing Resin)

Next, in step S3, the spin coating apparatus drips a second ultraviolet-curing resin to which to transfer unevenness either onto the inner periphery of the uneven surface of the substrate 11 or onto the center of the substrate 11, to let the second ultraviolet-curing resin spread from the inner periphery toward the outer periphery of the substrate 11. This forms a second ultraviolet-curing resin layer on the first ultraviolet-curing resin layer. In the description that follows, a multilayer body including the first and second ultraviolet-curing resin layers will be simply referred to as the ultraviolet-curing resin layer 13. The viscosity of the second ultraviolet-curing resin may preferably be set to be lower than the viscosity of the first ultraviolet-curing resin.

### (Process of Hardening Inner Periphery)

Next, in step S4, the ultraviolet irradiation apparatus irradiates the inner periphery of the uneven surface of the substrate 11 with ultraviolet light so as to cure the ultraviolet-curing resin layer 13 positioned along the inner periphery of the uneven surface of the substrate 11.

### (Process of Conveying Substrate)

Next, in step S5, the conveying apparatus conveys the substrate 11 from the spin coating apparatus to the load lock chamber (not depicted) of the vacuum press apparatus 50A, thereby placing the substrate 11 on the placement surface 52S of the table 52 located in the load lock chamber.

### (Process of Determining Number of Transfers)

Next, in step S6, the control apparatus 50B determines whether or not the number of transfers (press count) stored in the memory 50B1 has reached a prescribed number of transfers (i.e., transfer count prompting replacement of the elastic sheet 14). If it is determined in step S6 that the number of transfers has reached the prescribed transfer count, step S7 is reached. In step D7, the control apparatus 50B requests the administrative apparatus (host computer) that manages the whole manufacturing process of the optical recording medium 1 to stop the production lines of the optical recording medium 1, and stops the press operation of the vacuum press apparatus 50A at the same time. On the other hand, if it is determined in step S6 that the number of transfers has not reached the prescribed transfer count, step S8 is reached. In step S8, the number of transfers stored in the memory 50B1 is incremented, and the press operation of the vacuum press apparatus 50A is allowed to continue.

### (Process of Transfer by Stamper)

Next, under control of the control apparatus 50B, the vacuum pump (not depicted) connected to the load lock chamber evacuates the load lock chamber to depressurize its interior down to a prescribed degree of vacuum. Thereafter, under control of the control apparatus 50B, the table drive apparatus, not depicted, moves the table 52 from the load lock chamber to the vacuum chamber 51.

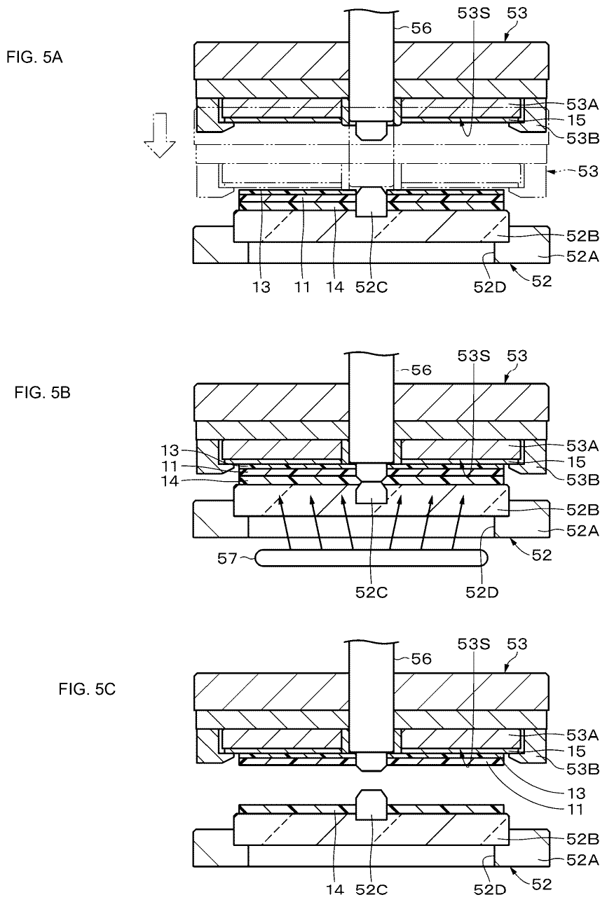

Next, in step S9, under control of the control apparatus 50B, the drive apparatus 54 lowers the ram 53 toward the placement surface 52S of the table 52 as depicted in FIG. 5A, and presses the stamper 15 onto the ultraviolet-curing resin layer 13 (specifically the second ultraviolet-curing resin layer).

Next, in step S10, under control of the control apparatus 50B, with the stamper 15 pressed onto the ultraviolet-curing resin layer 13 (specifically the second ultraviolet-curing resin layer) as illustrated in FIG. 5B, the ultraviolet irradiation apparatus 57 irradiates the ultraviolet-curing resin layer 13 with ultraviolet light from the back side of the table 52 in order to cure the ultraviolet-curing resin layer 13.

Next, in step S11, the control apparatus 50B controls the drive apparatuses 54 and 55 to separate the stamper 15 from the ultraviolet-curing resin layer 13 in the following manner. First, under control of the control apparatus 50B, the drive apparatus 54 lifts the ram 53 as depicted in FIG. 5C. This lifts the substrate 11 stuck on the stamper 15 via the ultraviolet-curing resin layer 13, together with the stamper 15 held on the press surface 53S of the ram 53. Next, under control of the control apparatus 50B, the drive apparatus 55 lowers the eject pin 56 to form a gap between the inner periphery of the stamper 15 and the inner periphery of the ultraviolet-curing resin layer 13. The gap can then be formed between the inner periphery of the stamper 15 and that of the ultraviolet-curing resin layer 13 because the ultraviolet-curing resin layer 13 along the inner periphery of the substrate 11 was hardened beforehand in the above-described inner periphery curing process.

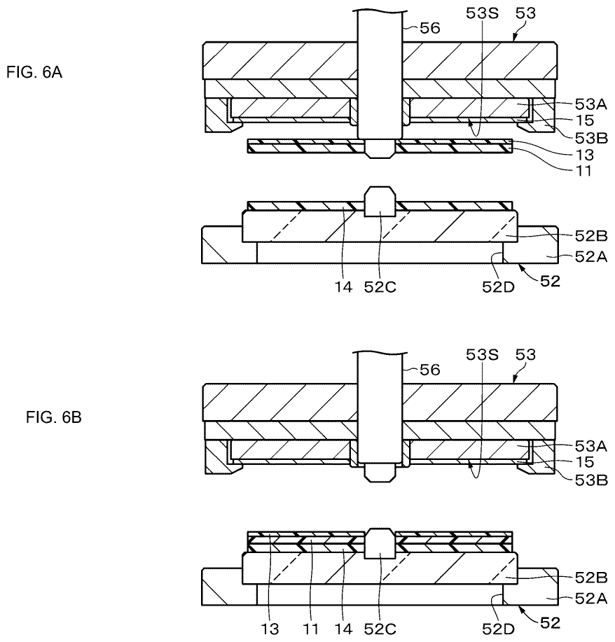

Then, under control of the control apparatus 50B, a compressor, not depicted, ejects compressed gas such as compressed air through multiple holes at the tip part of the eject pin 56. This causes the ultraviolet-curing resin layer 13 to be separated from the stamper 15 as illustrated in FIG. 6A. The separation allows the center hole of the substrate 11 to fall out from the tip of the eject pin 56, causing the substrate 11 to drop onto the placement surface 52S of the table 52. This is how the intermediate layer S1 is formed on the information signal layer L0.

In the above stamper transfer process, the control apparatus 50B controls the operation of the drive apparatus 54 at the time of transfer, i.e., the operation of pressing the stamper 15 onto the ultraviolet-curing resin layer 13, based on the press pressure and the press time stored in the memory 50B1. The press pressure (axial force), press pressure, and press time are as described above.

### (Process of Conveying Substrate)

Next, under control of the control apparatus 50B, the table drive apparatus, not depicted, moves the table 52 from the vacuum chamber 51 to the load lock chamber. Thereafter, under control of the control apparatus 50B, the vacuum valve (not depicted) connected to the load lock chamber opens it to the atmosphere. The conveying apparatus, not depicted, conveys the substrate 11 with the intermediate layer S1 formed thereon from the vacuum press apparatus 50A to the ultraviolet irradiation apparatus, placing the substrate 11 into a prescribed position.

(Process of Irradiation with Ultraviolet Light)

Next, in step S12, the ultraviolet irradiation apparatus irradiates the intermediate layer S1 with ultraviolet light to promote its curing.

### (Process of Conveying Substrate)

Next, the conveying apparatus conveys the substrate 11 from the ultraviolet irradiation apparatus to an inspection apparatus, placing the substrate 11 into a prescribed position.

### (Process of Inspecting Thickness of Intermediate Layer)

Next, in step S13, the inspection apparatus inspects the thickness of the intermediate layer S1 to determine whether or not thickness falls within a prescribed range. In a case where the inspection results in a passe in step S13, i.e., where the thickness of the intermediate layer S1 is determined to fall within the prescribed range in step S13, step S14 is reached. in step S14, the conveying apparatus conveys the substrate 11 to the sputtering apparatus. On the other hand, in a case where the inspection results in a fail in step S13, i.e., where the thickness of the intermediate layer S1 is determined not to fall within the prescribed range in step S13, step S15 is reached. In step S15, the inspection apparatus requests the administrative apparatus (host computer) managing the entire manufacturing process of the optical recording medium 1 to step the production lines of the optical recording medium 1.

### 5. ADVANTAGEOUS EFFECTS

As discussed above, the optical recording medium manufacturing method as one embodiment of the present disclosure involves the process of successively coating the first ultraviolet-curing resin and the second ultraviolet-curing resin on the information signal layer L using the spin coating apparatus, and the process of transferring unevenness to the second ultraviolet-curing resin by pressing the stamper 15 thereon using the vacuum press apparatus 50A. In the transfer process, the press pressure is 11, 875 N or less and the press time is 0.8 s or less. This makes it possible to prevent the first and second ultraviolet-curing resins from moving from the inner and intermediate peripheries toward the outer periphery of the substrate 11, thereby suppressing generation of the swelling along the outer periphery of the intermediate layer S on the substrate 11. Consequently, the outer periphery of the optical recording medium can be prevented from swelling.

### 6. MODIFICATION EXAMPLES

### Modification Example 1

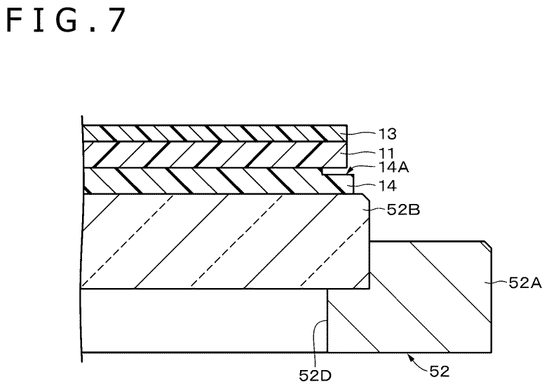

As depicted in FIG. 7, the elastic sheet 14 may be shaped in a manner having a gap with respect to the outer periphery of the substrate 11. For example, the elastic sheet 14 may have a stepped part 14A opposite to the outer periphery of the substrate 11. The stepped part 14A descends from the center of the substrate 11 toward its outer periphery. The elastic sheet 14 may alternatively have an inclined part opposite to the outer periphery of the substrate 11. The inclined part descends from the center of the substrate 11 toward its outer periphery.

In a case where the elastic sheet 14 of the above-described shape is used, there occurs a gap between the elastic sheet 14 and the outer periphery of the substrate 11. This mitigates the reaction force of the elastic sheet 14 against the outer periphery of the substrate 11. As a result, the press pressure against the outer periphery of the substrate 11 is reduced, which in turn suppresses generation of the swelling along the outer periphery of the intermediate layer S.

### Modification Example 2

It was explained, for example, that the optical recording medium 1 fabricated by the transfer apparatus 50 and the optical recording medium manufacturing method embodying the present disclosure is structured with the first disc 10 and the second disc 20 being bonded together, that the first disc 10 is irradiated on its side by the laser beam to write or read information signals thereto or therefrom, and that the second disc 20 is irradiated on its side by the laser beam to write or read information signals thereto or therefrom (e.g., AD (Archival Disc)). However, this example is not limitative of the optical recording medium 1 fabricated by the transfer apparatus 50 and the optical recording medium manufacturing method.

For example, the optical recording medium 1 fabricate by the transfer apparatus 50 and the optical recording medium manufacturing method may be an optical recording medium structured with an information signal layer, an intermediate layer, an information signal layer, . . . , an intermediate layer, an information signal layer, and a light-transmitting layer stacked in that order on a substrate, the information signal layers being irradiated on the light-emitting layer side by a laser beam to write or read information signals thereto or therefrom (e.g., BD (Blu-ray (registered trademark) Disc).

Alternatively, the optical recording medium 1 fabricated by the transfer apparatus 50 and the optical recording medium manufacturing method may be an optical recording medium structured with an information signal layer, an intermediate layer, an information signal layer, . . . , an intermediate layer, an information signal layer, and a protective layer stacked in that order on a substrate, the information signal layers being irradiated on the substrate side by a laser beam to write or read information signals thereto or therefrom (e.g., CD (Compact Disc)).

As another alternative, the optical recording medium 1 fabricated by the transfer apparatus 50 and the optical recording medium manufacturing method may be an optical recording medium structured with an information signal layer, an intermediate layer, an information signal layer, . . . , an intermediate layer, and an information signal layer stacked between two substrates, the information signal layers being irradiated on one substrate side by a laser beam to write or read information signals thereto or therefrom (e.g., DVD (Digital Versatile Disc)).

### Modification Example 3

It is explained, for example, that the optical recording medium 1 fabricated by the transfer apparatus 50 and the optical recording medium manufacturing method embodying the present disclosure is the write-once optical recording medium. Alternatively, the optical recording medium 1 fabricated by the transfer apparatus 50 and the optical recording medium manufacturing method may be a rewritable optical recording medium or a read-only optical recording medium. Thus, the recording layer 41 is not limited to the write-once recording layer, and may be a rewritable recording layer or a read-only recording layer. The layer structure of the information signal layers L is not limited to those of the above-described examples and may be varied depending on the type of the optical recording medium 1 or according to desired characteristics.

### Other Modification Examples

It is to be understood that while some embodiments and modification examples of the present disclosure have been explained in specific terms, these embodiments and modification examples are not limitative of this disclosure and that diverse variations are possible based on the technical scope of this disclosure. For instance, the structures, methods, processes, shapes, materials, and numbers described in connection with the above embodiments and modification examples are merely examples and that different structures, methods, processes, shapes, materials, and numbers may be used as needed. The structures, methods, processes, shapes, materials, and numbers of the above embodiments and modification examples may be combined with one another unless they depart from the scope of the present disclosure. In the numerical ranges described in stages in connection with the above embodiments and modification examples, the upper or lower limit of the numerical range in a given stage may be replaced with the upper or lower limit of the numerical range in another stage. The materials listed above for the above embodiments and modification examples may each be used singly or may be used in combination unless otherwise noted.

Note that the present disclosure may be implemented preferably in the following configurations.

(1)

An optical recording medium manufacturing method including:
coating an ultraviolet-curing resin on a recording layer of a substrate;
placing the substrate coated with the ultraviolet-curing resin onto an elastic sheet of a vacuum press apparatus; and
pressing a stamper onto the ultraviolet-curing resin to transfer unevenness thereto, in which
a press pressure at a time of the transfer is 11,875 N or less and a press time at the time of the transfer is 0.8 s or less.
   (2)

The optical recording medium manufacturing method according to (1), in which the press time at the time of the transfer is 0.4 s or less.

(3)

The optical recording medium manufacturing method according to (1) or (2), in which the press pressure at the time of the transfer is 2,375 N or less.

(4)

The optical recording medium manufacturing method according to any one of (1) to (3), in which the stamper is a metal stamper.

(5)

The optical recording medium manufacturing method according to any one of (1) to (4), in which the elastic sheet is capable of forming a gap between the elastic sheet and an outer periphery of the substrate.

(6)

The optical recording medium manufacturing method according to any one of (1) to (5), in which
the elastic sheet has either a stepped part or an inclined part in a portion thereof facing to the outer periphery of the substrate, and
the stepped part or the inclined part descends from a center of the substrate toward the outer periphery thereof.
   (7)

The optical recording medium manufacturing method according to any one of (1) to (6), in which the elastic sheet is a silicone sheet.

(8)

An optical recording medium manufacturing method including:
coating a first ultraviolet-curing resin on a recording layer of a substrate and curing the resin;
coating a second ultraviolet-curing resin on the first ultraviolet-curing resin;
placing the substrate coated with the second ultraviolet-curing resin onto an elastic sheet of a vacuum press apparatus; and
pressing a stamper onto the second ultraviolet-curing resin to transfer unevenness thereto, in which
a press pressure at a time of the transfer is 11,875 N or less and a press time at the time of the transfer is 0.8 s or less.
   (9)

A transfer apparatus for an optical recording medium, including:
a vacuum press apparatus configured to press a stamper onto an ultraviolet-curing resin to transfer unevenness thereto; and
a control apparatus configured to control the vacuum press apparatus, in which
the vacuum press apparatus includes
   a ram capable of holding the stamper,
   a table capable of placing an elastic sheet, and
   a drive apparatus capable of moving the ram in a direction approaching the table as well as in a direction separating therefrom, and
the control apparatus controls the drive apparatus in such a manner that a press pressure becomes 11, 875 N or less and that a press time becomes 0.8 s or less.
   (10)

The transfer apparatus for the optical recording medium according to (9), in which the control apparatus counts the number of times a press is performed after replacement of the elastic sheet and, when the press count has reached a prescribed count, stops the drive apparatus.

(11)

The transfer apparatus for the optical recording medium according to (9), in which the control apparatus counts the number of times a press is performed after replacement of the elastic sheet and, when the press count has reached a prescribed count, gives notification prompting replacement of the elastic sheet.

### EMBODIMENTS

The present disclosure is described below in specific terms using embodiments. It is to be noted that these embodiments are not limitative of this disclosure.

In the description that follows, three signal information layers in a three-layer optical recording medium will be referred to as “layer L0,” “layer L1,” and “layer L2” ranging from a substrate to a laser beam irradiation surface. Two intermediate layers included in the three-layer optical recording medium will be referred to as “layer S1” and “layer S2” ranging from the substrate to the laser beam irradiation surface.

### <Verification of Generation of Swelling>

The three-layer optical recording medium was fabricated, and the amount of the swelling generated along its outer periphery was measured.

### Reference Example 1

### (Process of Forming Substrate)

First, an injection molding apparatus was used to fabricate a platter-like polycarbonate substrate (referred to as “PC substrate” hereunder) with a diameter of 120 mm. At this time, an unevenness constituted of lands and grooves was formed on one principal surface of the PC substrate.

### (Process of Depositing Layer L0)

Next, the sputtering apparatus was used to deposit the layer L0 by successive stacking of a second dielectric layer, a recording layer, and a first dielectric layer on the uneven surface of the PC substrate.

### (Process of Forming Layer S1)

Next, a process of coating the first ultraviolet-curing resin, a process of coating the second ultraviolet-curing resin, and a process of transfer by the stamper, to be discussed below, resulted in depositing of the layer S1 with a thickness of 25 μm on the layer L0.

### (Process of Coating First Ultraviolet-Curing Resin)

First, while the spin coating apparatus was being used to coat the first ultraviolet-curing resin serving as a base layer on the layer L0 of the PC substrate, the infrared irradiation apparatus was used to irradiate the outer periphery of the uneven surface (film-forming surface) of the substrate 11 with infrared light. This formed the first ultraviolet-curing resin layer on the layer L0 of the substrate 11. Next, the spin coating apparatus was used to rotate the substrate 11 so as to remove, by use of centrifugal force, the swelling of the first ultraviolet-curing resin layer generated along the outer periphery of the uneven surface of the substrate 11.

### (Process of Coating Second Ultraviolet-Curing Resin)

Next, the spin coating apparatus was used to coat the second ultraviolet-curing resin to which to transfer unevenness on the first ultraviolet-curing resin. This formed the second ultraviolet-curing resin layer on the first ultraviolet-curing resin layer. In the ensuing description, a multilayer body including the first and second ultraviolet-curing resin layers will be simply referred to as the ultraviolet-curing resin layer. The viscosity of the second ultraviolet-curing resin was set to be lower than the viscosity of the first ultraviolet-curing resin. Next, a UV lamp was used to irradiate the inner periphery of the uneven surface of the PC substrate with ultraviolet light so as to cure the ultraviolet-curing resin layer positioned on the inner periphery of the uneven surface of the PC substrate.

### (Process of Transfer by Stamper)

Next, the vacuum press apparatus depicted in FIG. 3 was used to transfer, in a vacuum environment, the unevenness of the stamper to the ultraviolet-curing resin layer in a manner similar to the process of transfer by the stamper discussed in connection with the above embodiment. It is to be noted that the press pressure (axial force) of the vacuum press apparatus was set to 11,875 N, the press pressure to 1.05 n/mm², and the press time to 1.7 sec. A nickel stamper was used as the stamper.

### (Process of Depositing Layer L1)

Next, the sputtering apparatus was used to deposit the layer L1 by successive stacking of the second dielectric layer, recording layer, and first dielectric layer onto the uneven surface of the layer S1.

### (Process of Forming Layer S2)

Next, in a manner similar to the above process of forming the layer S1, the layer S2 with a thickness of 18 μm was formed on the layer L1.

### (Process of Depositing Layer L2)

Next, the sputtering apparatus was used to deposit the layer L2 by successive stacking of the second dielectric layer, recording layer, and first dielectric layer on the uneven surface of the layer L2.

### (Process of Forming Light-Transmitting Layer)

Next, the spin coating method was used to coat the ultraviolet-curing resin on the layer L3, the ultraviolet-curing resin being irradiated with ultraviolet light for curing. This formed the light-transmitting layer with a thickness of 57 μm. This was how a sample 1 (three-layer optical recording medium) is obtained.

### (Measurement of Thickness T)

The thickness T of the sample 1 obtained as described above was measured in positions in a full circle of the same radius. The measurements were taken at intervals of 0.5 mm in the radial direction. The thickness T is a thickness that ranges from the surface of the layer L0 to the surface of the light-transmitting layer (laser beam irradiation surface, see FIG. 1). The thickness T is approximately equal to the sum of the thickness of the layer S2 and the thickness of the layer S1. ARGUS-EX available from Dr. Schwab Inc. was used to measure the thickness T.

### [Measurement Results]

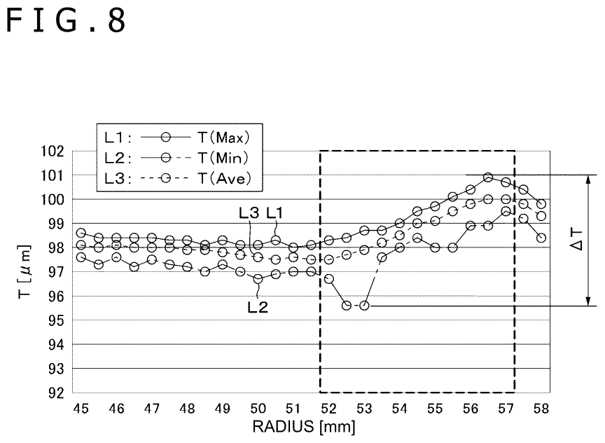

FIG. 8 indicates measurement results of the thickness T at different radii. A curve L1 in FIG. 8 indicates a maximum value T(Max) of the thickness T measured at the same radius. A curve L2 in FIG. 8 indicates a minimum value T(Min) of the thickness T measured at the same radius. A curve L3 in FIG. 8 indicates an average value T(Ave) of the thickness T measured at the same radius.

Between the maximum value T(Max) and minimum value T(Min) along the outer periphery (between 45 mm and 58 mm inclusive in radius) of the sample 1, a difference ΔT(=T(Max)−T(Min)) was obtained. The difference thus acquired was taken as the amount of swelling ΔT along the outer periphery of the sample 1.

The thickness T is minimum at the radius R=52.5 mm and maximum at the radius R=56.5 mm. Depending on the position along the outer periphery, the thickness T varies by approximately 1 μm over a distance of 1 mm in the radial direction. The amount of swelling ΔT along the outer periphery is 5.3 μm.

With the layer L2 covered by the light-transmitting layer (cover layer), the changes in thickness of the layers S1 and S2 are somewhat mitigated. As long as the amount of swelling ΔT along the outer periphery is limited to 3.0 μm or less, it is possible to suppress occurrence of defects during writing or reading. In order to limit the amount of swelling ΔT along the outer periphery to 3.0 μm or less, it is preferred that the amount of swelling ΔT₁ of the layer S1 and the amount of swelling ΔT₂ of the layer S2 meet the following requirements: ΔT₁≤2.0 μm and ΔT₂≤1.3 μm. Here, the amount of swelling ΔT₁ along the outer periphery of the layer S1 stands for the amount of change in thickness of the layer S1 alone, representing the amount of abrupt variations in layer thickness near a region between 50 mm and 57 mm in radius of the layer S1 only. Likewise, the amount of swelling ΔT₂ along the outer periphery of the layer S2 stands for the amount of change in thickness of the layer S2 alone, representing the amount of abrupt variations in layer thickness near the region between 50 mm and 57 mm in radius of the layer S2 only.

<Identification of Process that Triggers Swelling>

In each of the processes included in the process of fabricating the intermediate layer, the amount of swelling of the ultraviolet-curing resin was verified. This led to the determination of which of the processes included in the process of forming the intermediate layer triggers the swelling of the ultraviolet-curing resin.

### Reference Example 2-1

First, the processes ranging from forming the substrate to coating the first ultraviolet-curing resin were performed to obtain a sample 2-1. The processes ranging from forming the substrate to coating the first ultraviolet-curing resin to were similar to those for the reference example 1.

### [Measurement of Thickness T₁₁]

Next, the thickness Tu of the sample 2-1 was measured in positions in a full circle of the same radius. The measurements were taken at intervals of 0.5 mm in the radial direction. The thickness Tu is a thickness that ranges from the surface of the layer L0 to the surface of the first ultraviolet-curing resin layer. Note that ARGUS-EX available from Dr. Schwab Inc. was used to measure the thickness T₁₁.

### Reference Example 2-2

First, the processes ranging from forming the substrate to coating the second ultraviolet-curing resin were performed to obtain a sample 2-2. These processes were similar to those for the reference example 1.

### [Measurement of Thickness T₁₂]

Next, the thickness T₁₂ of the sample 2-2 was measured in positions in a full circle of the same radius. The measurements were taken at intervals of 0.5 mm in the radial direction. The thickness T₁₂ is a thickness that ranges from the surface of the layer L0 to the surface of the second ultraviolet-curing resin layer. Note that ARGUS-EX available from Dr. Schwab Inc. was used to measure the thickness T₁₂.

### [Reference Sample 2-3]

First, the processes ranging from forming the substrate to transfer by the stamper were performed to obtain a sample 2-3. The processes ranging from forming the substrate to transfer by the stamper were similar to those for the reference example 1.

### [Measurement of Thickness T₁₃]

Next, the thickness T₁₃ of the sample 2-3 was measured in positions in a full circle of the same radius. The measurements were taken at intervals of 0.5 mm in the radial direction. The thickness T₁₃ is a thickness that ranges from the surface of the layer L0 to the surface of the second ultraviolet-curing resin layer after transfer. Note that ARGUS-EX available from Dr. Schwab Inc. was used to measure the thickness T₁₃.

### [Measurement Results]

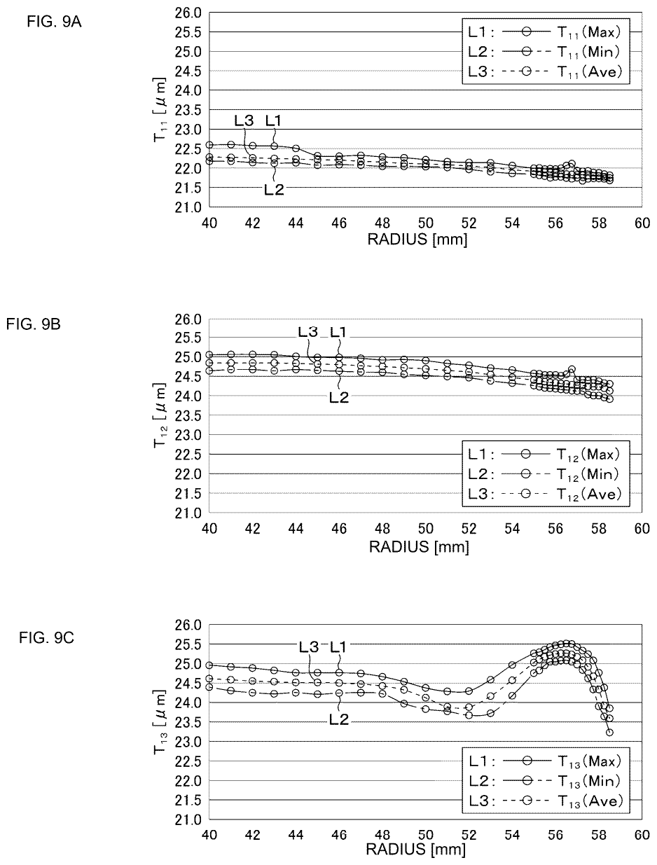

FIG. 9A indicates measurement results of the thickness T₁₁ of the sample 2-1. A curve L1 in FIG. 9A indicates a maximum value T₁₁(Max) of the thickness Tu of the sample 2-1 measured at the same radius. A curve L2 in FIG. 9A indicates a minimum value T₁₁(Min) of the thickness Tu of the sample 2-1 measured at the same radius. A curve L3 in FIG. 9A indicates an average value T₁₁(Ave) of the thickness Tu of the sample 2-1 measured at the same radius.

FIG. 9B indicates measurement results of the thickness T₁₂ of the sample 2-2. A curve L1 in FIG. 9B indicates a maximum value T₁₂(Max) of the thickness T₁₂ of the sample 2-2 measured at the same radius. A curve L2 in FIG. 9B indicates a minimum value T₁₂(Min) of the thickness T₁₂ of the sample 2-2 measured at the same radius. A curve L3 in FIG. 9B indicates an average value T₁₁(Ave) of the thickness T₁₂ of the sample 2-2 measured at the same radius.

FIG. 9C indicates measurement results of the thickness T₁₃ of the sample 2-3. A curve L1 in FIG. 9C indicates a maximum value T₁₃(Max) of the thickness T₁ of the sample 2-3 measured at the same radius. A curve L2 in FIG. 9C indicates a minimum value T₁₃(Min) of the thickness T₁₃ of the sample 2-3 measured at the same radius. A curve L3 in FIG. 9C indicates an average value T₁₃(Ave) of the thickness T₁₃ of the sample 2-3 measured at the same radius.

From FIGS. 9A, 9B, and 9C, it will be understood that there has occurred a swelling along the outer periphery following the process of transfer by the vacuum press apparatus.

### <Verification of Relation Between Press Force and Amount of Swelling>

Given the above results, a hypothesis was formulated that the swelling is generated at the time of transfer by the press force moving the second ultraviolet-curing resin from the inner and intermediate peripheries toward the outer periphery. On that hypothesis, the relation between the press force (press pressure (axial force), press pressure, and press time) and the amount of swelling was verified while the press force was being varied.

### Embodiment 3-1

Except that the press time of the vacuum press apparatus was set to 0.8 sec, the settings involved were made similar to those for the reference sample 2-3 in order to obtain a sample 3-1.

### Embodiment 3-2

Except that the press time of the vacuum press apparatus was set to 0.4 sec, the settings involved were made similar to those for the reference sample 2-3 in order to obtain a sample 3-2.

### Embodiment 3-3

Except that the press pressure (axial force) of the vacuum press apparatus was set to 2, 375 N and that the press pressure was set to 0.21 N/mm², the settings involved were made similar to those for the reference example 3-2 in order to obtain a sample 3-3.

### [Measurement of Thickness T₁₃ Along Outer Periphery]

Next, measurements were taken of the thickness T₁ of the above-obtained samples 3-1 through 3-2 in positions in a full circle of the same radius, in a manner similar to that for the sample 2-3. The measurements were taken at intervals of 1 mm or 0.25 mm in the radial direction.

### [Measurement Results]

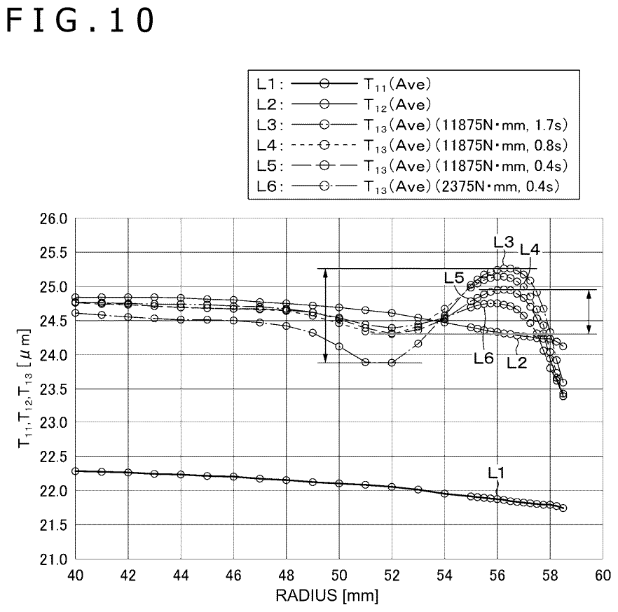

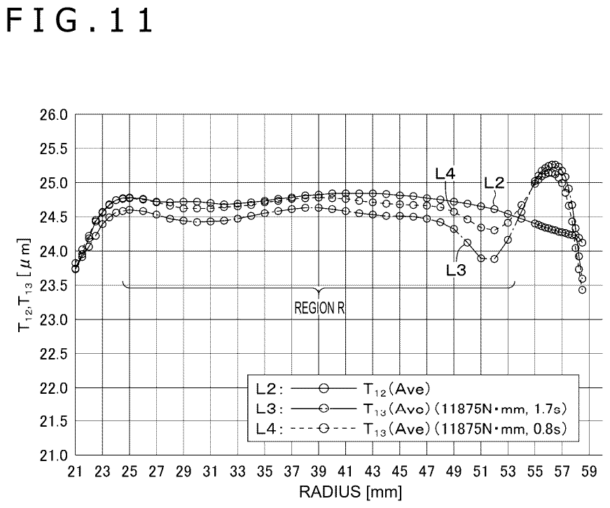

FIG. 10 indicates measurement results of the thickness T₁₁(Ave) of the sample 2-1, thickness T₁₂(Ave) of the sample 2-2, and thickness T₁₃ of the samples 2-3, 3-1, 3-2, and 3-3 over a range of between 40.0 mm and 58.5 mm inclusive in radius. FIG. 11 indicates measurement results of the thickness T₁₂(Ave) of the sample 2-2 and the thickness T₁₃ of the samples 2-3 and 3-1 over a range of between 21.0 mm and 58.5 mm inclusive in radius.

A curve L1 in FIG. 10 indicates an average value T₁₁(Ave) of the thickness Tu measured at the same radius (on sample 2-1). A curve L2 in FIGS. 10 and 11 indicates an average value T₁₂(Ave) of the thickness T₁₂ measured at the same radius (on sample 2-2). Curves L3 and L4 in FIGS. 10 and 11 indicate an average value T₁₃(Ave) of the thickness T₁₃ measured at the same radius (on samples 2-3 and 3-1). Curves L5 and L6 in FIG. 10 indicate an average value T₁₃(Ave) of the thickness T₁₃ measured at the same radius (on samples 3-2 and 3-3).

As described above, the thickness Tu stands for a thickness that ranges from the surface of the layer L0 to the surface of the first ultraviolet-curing resin layer, with the average value Tu (Ave) representing the average value of the thickness Tu measured at the same radius. The thickness T₁₂ stands for a thickness that ranges from the surface of the layer L0 to the surface of the second ultraviolet-curing resin layer before transfer, with the average value T₁₂(Ave) representing the average value of the thickness T₁₂ measured at the same radius. The thickness T₁₃ stands for a thickness that ranges from the surface of the layer L0 to the surface of the second ultraviolet-curing resin layer after transfer, with the average value T₁₃(Ave) representing the average value of the thickness T₁₃ measured at the same radius.

Given the samples 2-3, 3-1, 3-2, and 3-3, a difference ΔT₁ was obtained between the maximum value of T₁₃(Max) and the minimum value of T₁₃(Min) over a range of between 40.0 mm and 58.5 mm inclusive in radius (=maximum value of T₁₃(Max)−minimum value of T₁₃(Min)). The difference thus obtained was taken as the amount of swelling ΔT₁ along the outer periphery of the layer S1. Table 1 below lists calculation results of the amount of swelling ΔT₁ along the outer periphery of the layer S1.

TABLE 1

| | | | | Decreasing |
|---|---|---|---|---|
| | Press | | | rate of |
| | pressure | Press time | | swelling |
| | [N] | [s] | ΔT₁ [μm] | [%] |
| Sample 2-3 | 11875 | 1.7 | 1.38 | — |
| Sample 3-1 | 11875 | 0.8 | 0.84 | −39 |
| Sample 3-2 | 11875 | 0.4 | 0.64 | −54 |
| Sample 3-3 | 2375 | 0.4 | 0.36 | −74 |

The decreasing rate of swelling in Table 1 is given in reference to the amount of swelling ΔT₁ on the sample 2-3.

FIG. 10 and Table 1 reveal the following.

Shortening the press time can reduce the amount of swelling ΔT₁ along the outer periphery of the layer S1. In view of reducing the amount of swelling ΔT₁, the press time is 0.8 s or less, and preferably 0.4 s or less.

Lowering the press pressure can reduce the amount of swelling ΔT₁ along the outer periphery of the layer S1. In view of reducing the amount of swelling ΔT₁, the press pressure is 11,875 N or less, and preferably 2, 375 N or less.

Lowering the press pressure can reduce the amount of swelling ΔT₁ along the outer periphery of the layer S1. In view of reducing the amount of swelling ΔT₁, the press pressure is 1.05 N/mm² or less, and preferably 0.21 N/mm² or less.

From FIG. 11, it will be understood that the longer the press time, the thinner the thickness T₁₃(Ave) of the inner and intermediate peripheries (see the region R in FIG. 11) tends to become and the larger the amount of swelling ΔT₁ along the outer periphery tends to become.

The above tendencies verify that the swelling along the outer periphery of the optical recording medium is caused by the second ultraviolet-curing resin moving from the inner and outer peripheries (see the region R in FIG. 11) toward the outer periphery during the transfer process.

### <Number of Transfers and Change in Shape of Silicone Sheet Surface>

The vacuum press apparatus was used to perform transfer repeatedly, and the change in shape of the silicone sheet surface was inspected with respect to the transfer count.

### Reference Example 4

The vacuum press apparatus, with its silicone sheet (elastic sheet) replaced by an unused silicone sheet, was used to perform transfer (press) 1,300 times in a manner similar to that for the reference sample 2-3, before the thickness T was measured after 5 transfers and also after 1, 300 transfers. Here, the thickness T, as described above, is a thickness that ranges from the surface of the layer L0 to the surface of the light-transmitting layer (laser beam irradiation surface, see FIG. 1). Also measured were the shape of the surface of the unused silicone sheet (i.e., placement surface on which the PC substrate is placed), and the shape of the silicone sheet surface (i.e., placement surface on which the PC substrate is placed) after transfer counts of 200 and 500.

### (Measurement Results)

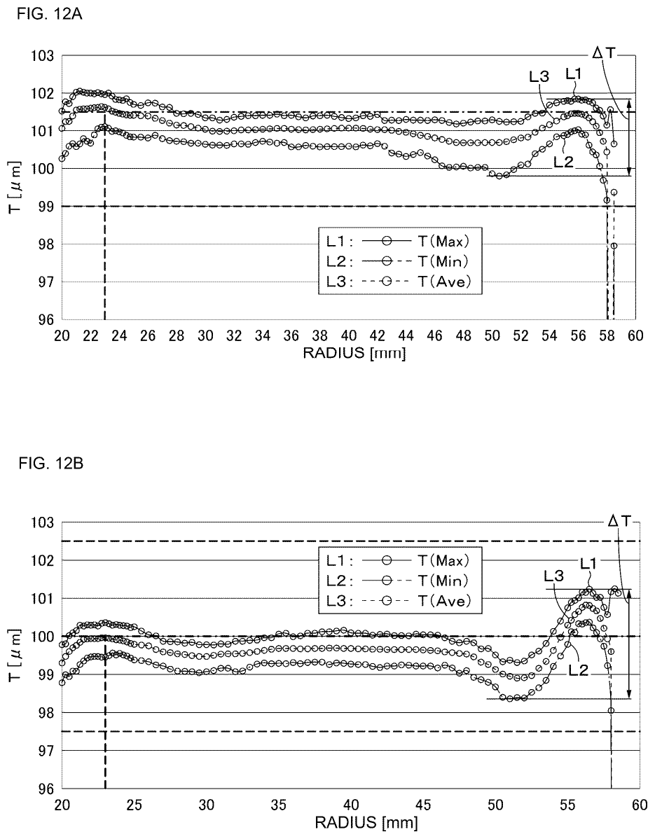

FIG. 12A indicates measurement results of the thickness T after the transfer count of 5. FIG. 12B indicates measurement results of the thickness T after the transfer count of 1,300. These measurement results verify the tendency of the amount of swelling ΔT along the outer periphery of the optical recording medium being on the increase in keeping with increases in the transfer count (press count).

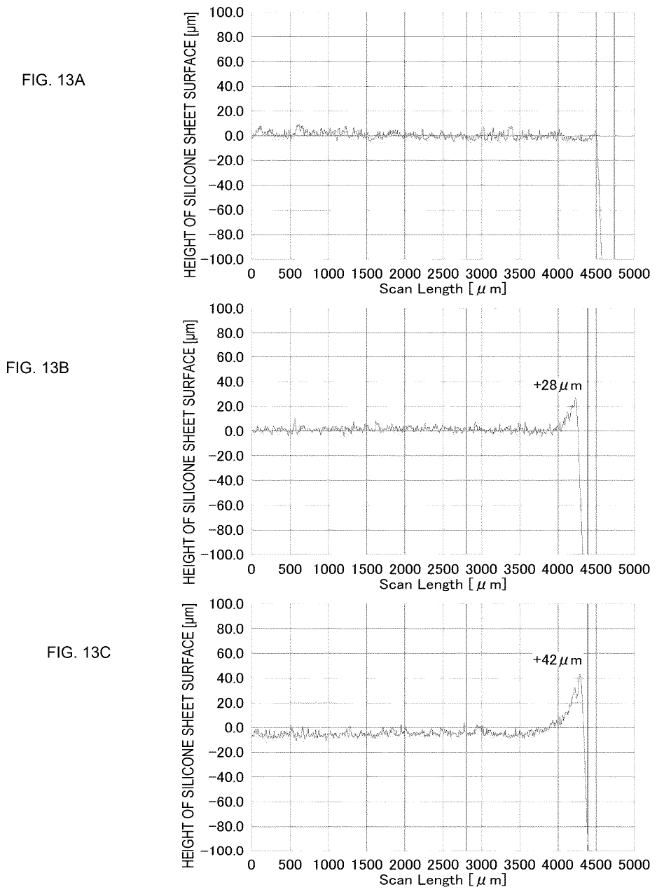

FIG. 13A depicts the shape of the surface of an unused silicone sheet. FIG. 13B depicts the shape of the silicone sheet surface after the transfer count of 200. FIG. 13C depicts the shape of the silicone sheet surface after the transfer count of 500. These results verify that the repeated transfers cause a swelling to occur along the outer periphery of the silicone sheet and that the swelling grows in keeping with increases in the transfer count.

What specifically takes place is as follows. Along the outer periphery of the surface of the unused silicone sheet, no swelling is observed (0 μm in swelling height). A swelling of approximately 30 μm in height is observed along the outer periphery of the silicone sheet surface after the transfer count of 200. A swelling of approximately 40 μm in height is observed along the outer periphery of the silicone sheet surface after the transfer count of 500.

The above measurement results reveal that limiting the number of times the silicone sheet is used also suppresses the swelling along the outer periphery of the optical recording medium.

### <Relation Between Number of Transfers and Amount of Swelling>

The vacuum press apparatus was used to perform transfer repeatedly before examining the change in the amount of swelling ΔT along the outer periphery of the optical recording medium in conjunction with the transfer count.

### Embodiment 5

A total of 2,000 samples (of a three-layer optical recoding medium) were fabricated in a manner similar to that for the reference example 1 except that the silicone sheet (elastic sheet) of the vacuum press apparatus was replaced by an unused silicone sheet and that the press time of the vacuum press apparatus was set to 0.8 sec. It is to be noted that the vacuum press apparatus used in the process of forming the layer S1 and the vacuum press apparatus used in the process of forming the layer S2 were different from each other.

During the process of fabricating the above samples, the amount of swelling ΔT₁ along the outer periphery of the layer L1, the amount of swelling ΔT₂ along the outer periphery of the layer L2, and the amount of swelling ΔT along the outer periphery of the optical recording medium were measured after fabricating every 100 samples.

### [Measurement Results]

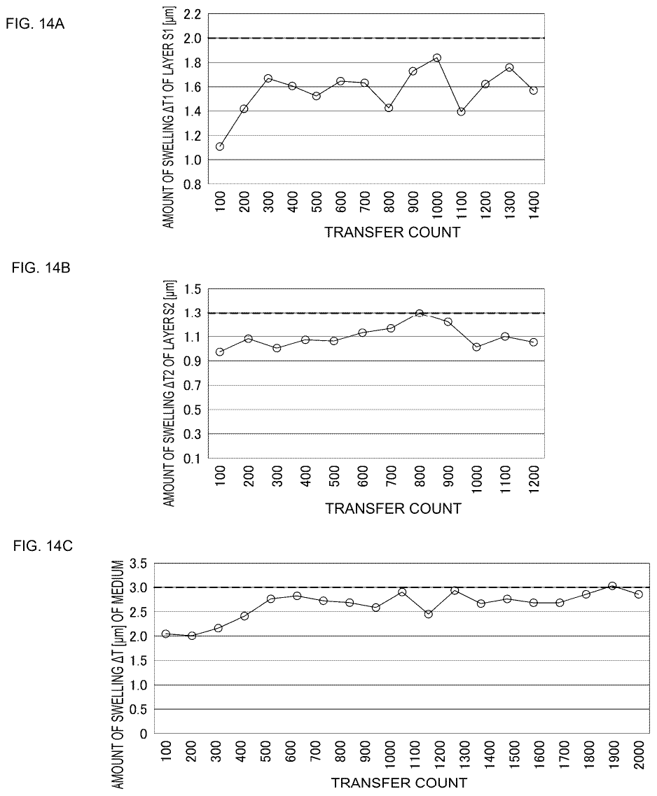

FIG. 14A indicates measurement results of the amount of swelling ΔT₁ along the outer periphery of the surface of the layer S1. FIG. 14B indicates measurement results of the amount of swelling ΔT₂ along the outer periphery of the surface of the layer S2. FIG. 14C indicates measurement results of the amount of swelling ΔT along the outer periphery of the surface of the optical recording medium.

The above measurement results reveal the tendency of the amount of swelling ΔT₁ along the outer periphery of the layer L1, of the amount of swelling ΔT₂ along the outer periphery of the layer L2, and of the amount of swelling ΔT along the outer periphery of the surface of the optical recording medium being on the increase in keeping with increasing numbers of transfers performed by the vacuum press apparatus. It is thus preferred that the number of transfers (press count) using the silicone sheet be counted and that the silicone sheet be replaced once a prescribed transfer count is reached.

### REFERENCE SIGNS LIST

1: Optical recording medium
10: First disc
20: Second disc
30: Bonding layer
11, 21: Substrate
12, 22: Light-transmitting layer
13: Ultraviolet-curing resin layer
14: Elastic sheet
14A: Stepped part
15: Stamper
41: Recording layer
42: Dielectric layer (first dielectric layer)
43: Dielectric layer (second dielectric layer)
L0 to Ln, L0 to Lm: Information signal layer
S1 to Sn, S1 to Sm: Intermediate layer
50: Transfer apparatus
50A: Vacuum press apparatus
50B: Control apparatus
50B1: Memory
51: Vacuum chamber
51A: Window
51B: Glass plate
52: Table
52A: Holder
52B: Glass tray
52C: Center pin
52D: Opening
52S: Placement surface
53: Ram
53A: Mold
53B: Outer peripheral ring
53S: Press surface
54, 55: Drive apparatus
54A: Shaft
54B: Holder
54C: Motor
56: Eject pin
57: Irradiation apparatus
58A: Vacuum pump
58B: Vacuum valve
59: Notification part

1. An optical recording medium manufacturing method comprising:
coating an ultraviolet-curing resin on a recording layer of a substrate;
placing the substrate coated with the ultraviolet-curing resin onto an elastic sheet of a vacuum press apparatus; and
pressing a stamper onto the ultraviolet-curing resin to transfer unevenness thereto, wherein
a press pressure at a time of the transfer is 11,875 N or less and a press time at the time of the transfer is 0.8 s or less.

2. The optical recording medium manufacturing method according to claim 1, wherein the press time at the time of the transfer is 0.4 s or less.

3. The optical recording medium manufacturing method according to claim 1, wherein the press pressure at the time of the transfer is 2, 375 N or less.

4. The optical recording medium manufacturing method according to claim 1, wherein the stamper is a metal stamper.

5. The optical recording medium manufacturing method according to claim 1, wherein the elastic sheet is capable of forming a gap between the elastic sheet and an outer periphery of the substrate.

6. The optical recording medium manufacturing method according to claim 1, wherein
the elastic sheet has either a stepped part or an inclined part in a portion thereof facing to the outer periphery of the substrate, and
the stepped part or the inclined part descends from a center of the substrate toward the outer periphery thereof.

7. The optical recording medium manufacturing method according to claim 1, wherein the elastic sheet is a silicone sheet.

8. An optical recording medium manufacturing method comprising:
coating a first ultraviolet-curing resin on a recording layer of a substrate and curing the resin;
coating a second ultraviolet-curing resin on the first ultraviolet-curing resin;
placing the substrate coated with the second ultraviolet-curing resin onto an elastic sheet of a vacuum press apparatus; and
pressing a stamper onto the second ultraviolet-curing resin to transfer unevenness thereto, wherein
a press pressure at a time of the transfer is 11,875 N or less and a press time at the time of the transfer is 0.8 s or less.

9. A transfer apparatus for an optical recording medium, comprising:
a vacuum press apparatus configured to press a stamper onto an ultraviolet-curing resin to transfer unevenness thereto; and
a control apparatus configured to control the vacuum press apparatus, wherein
the vacuum press apparatus includes a ram capable of holding the stamper,
a table capable of placing an elastic sheet, and
a drive apparatus capable of moving the ram in a direction approaching the table as well as in a direction separating therefrom, and
the control apparatus controls the drive apparatus in such a manner that a press pressure becomes 11, 875 N or less and that a press time becomes 0.8 s or less.

10. The transfer apparatus for the optical recording medium according to claim 9, wherein the control apparatus counts the number of times a press is performed after replacement of the elastic sheet and, when the press count has reached a prescribed count, stops the drive apparatus.

11. The transfer apparatus for the optical recording medium according to claim 9, wherein the control apparatus counts the number of times a press is performed after replacement of the elastic sheet and, when the press count has reached a prescribed count, gives notification prompting replacement of the elastic sheet.
